(19) United States
(12) Patent Application Publication
(10) Pub. No.: US 2012/0069395 A1
(43) Pub. Date: Mar. 22, 2012

(54) IMAGE FORMING APPARATUS AND JOB LOG MANAGEMENT METHOD

(75) Inventor: Kou Hiraike, Yokohama-shi (JP)

(73) Assignee: CANON KABUSHIKI KAISHA, Tokyo (JP)

(21) Appl. No.: 13/231,786

(22) Filed: Sep. 13, 2011

(30) Foreign Application Priority Data
Sep. 21, 2010 (JP) 2010-210874

(51) Int. Cl. G06F 15/00

(52) U.S. Cl. 358/1.15

(57) ABSTRACT

An image forming apparatus capable of transmitting a job log relating to a processed job to a first storage apparatus existing on an Internet outside a firewall and a second storage apparatus existing inside a firewall includes an identification unit configured to identify a job log to be generated when a job is processed as a job log to be transmitted to the first storage apparatus or a job log to be transmitted to the second the storage apparatus according to information for identifying a transmission destination included in the job, and a transmission unit configured to transmit the generated job log to the transmission destination identified by the identification unit.

### BACKGROUND OF THE INVENTION

1. Field of the Invention

The present invention relates to a technique for collecting and managing job logs generated by an image forming apparatus.

2. Description of the Related Art

There exists a system in which a print job is transmitted from a personal computer (PC) to a print server and temporarily stored therein, and a multifunction peripheral having a copy function, a scanner function, a facsimile function, a printer function, and the like acquires and prints the print job from the print server. In such a system, when printing or facsimile transmission or the like is performed, a job log as an execution history of the job is generated.

An example of collection of the job logs, a technique for changing items to be tallied up according to selection by a user when tallying the job logs to obtain a suitable summary result is discussed in Japanese Patent Application Laid-Open No. 2004-178325).

If a server for collecting and managing the job logs is arranged on the Internet, the job logs can be collected from a plurality of workstations, and the burden associated with construction of infrastructure can be reduced by sharing the server.

However, if the server for collecting and managing the job logs is arranged on the Internet, the release of confidential information or private information included in the job logs can occur.

### SUMMARY OF THE INVENTION

The present invention is directed to a technique for appropriately managing a job log.

According to an aspect of the present invention, an image forming apparatus capable of transmitting a job log relating to a processed job to a first storage apparatus and a second storage apparatus, the image forming apparatus including a processing unit configured to identify a job log, generated when a job is processed, as a job log to be transmitted to the first storage apparatus or a job log to be transmitted to the second the storage apparatus, wherein information identifying a transmission destination of the job is included in the job, and an interface unit configured to transmit the generated job log to the transmission destination.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a job log management system.

FIG. 2 illustrates an example of a hardware configuration of a multifunction peripheral.

FIG. 3 illustrates an example of a sequence of operations of a PC, a multifunction peripheral, and servers.

FIG. 4 illustrates an example of a configuration of a job log.

FIGS. 5A and 5B illustrate an example of a flowchart for print job transmission processing.

FIG. 6 illustrates an example of a flowchart for processing at the time of printing.

FIG. 7 illustrates an example of a flowchart for print processing.

FIG. 8 illustrates an example of a flowchart for transmission destination setting processing.

FIG. 9 illustrates an example of a screen for setting a transmission destination of a job log.

FIG. 10 illustrates an example of a flowchart for job log transmission processing.

FIG. 11 illustrates an example of a flowchart for counting processing.

FIG. 12 illustrates an example of a screen displayed on a display.

FIG. 13 illustrates an example of a screen displayed on a display.

FIG. 14 illustrates an example of a screen displayed on a display.

FIG. 15 illustrates an example of a configuration of a print engine unit.

FIG. 16 illustrates an example of a flowchart for processing at the time of printing.

FIGS. 17A and 17B illustrate an example of a flowchart for job log transmission processing.

### DESCRIPTION OF THE EMBODIMENTS

Various exemplary embodiments, features, and aspects of the invention will be described in detail below with reference to the drawings.

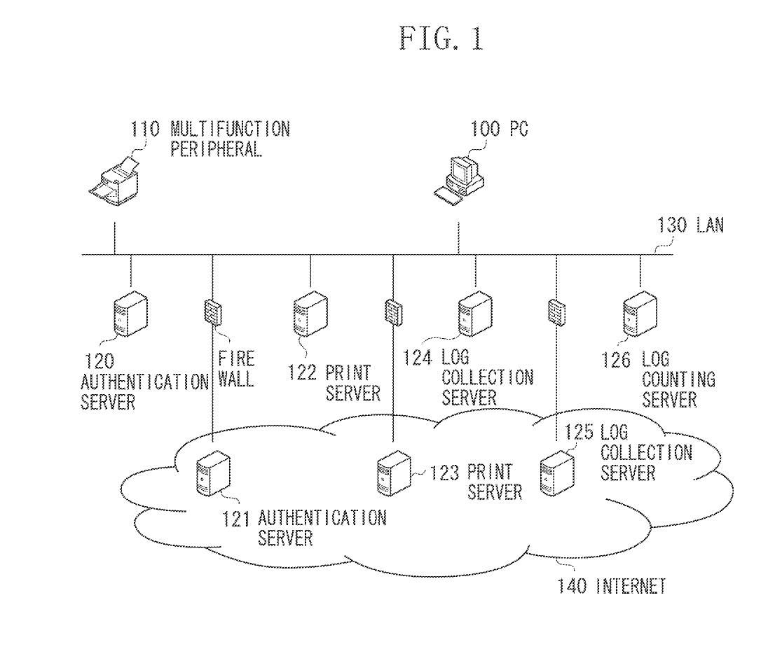

FIG. 1 illustrates an example of a configuration of a job log management system according to a first exemplary embodiment. The job log management system includes a PC 100, a multifunction peripheral 110, and various servers 120 to 126. These apparatuses are connected to one another via a local area network (LAN) 130. The PC 100 and the servers 120 to 126 are examples of information processing apparatuses. The multifunction peripheral 110 includes a copy function, a scanner function, a facsimile function, a printer function and the like, and is an example of an image forming apparatus.

Authentication servers 120 and 121 perform user authentication of the PC 100, the multifunction peripheral 110 and the like. Print servers 122 and 123 are examples of a management apparatus, and manage (e.g., temporarily store) a print job transmitted from the PC 100. The print job is acquired and printed by the multifunction peripheral 110.

Log collection servers 124 and 125 temporarily store a job log generated when the multifunction peripheral 110 performs printing. The job log is regularly transmitted from the multifunction peripheral 110 to the log collection server 124 or 125. A log counting server 126 counts and manages (e.g., stores) the job logs acquired from the log collection servers 124 and 125.

The authentication server 121, the print server 123, and the log collection server 125 are located outside the LAN 130 and connect to the LAN from the Internet 140 via a firewall. The present exemplary embodiment is not limited to the configuration illustrated in FIG. 1. For example, one or a plurality of the PCs 100 and/or the multifunction peripherals 110 may be connected directly with each other. In another example, the PC 100 can be connected to the LAN 130 via the Internet 140.

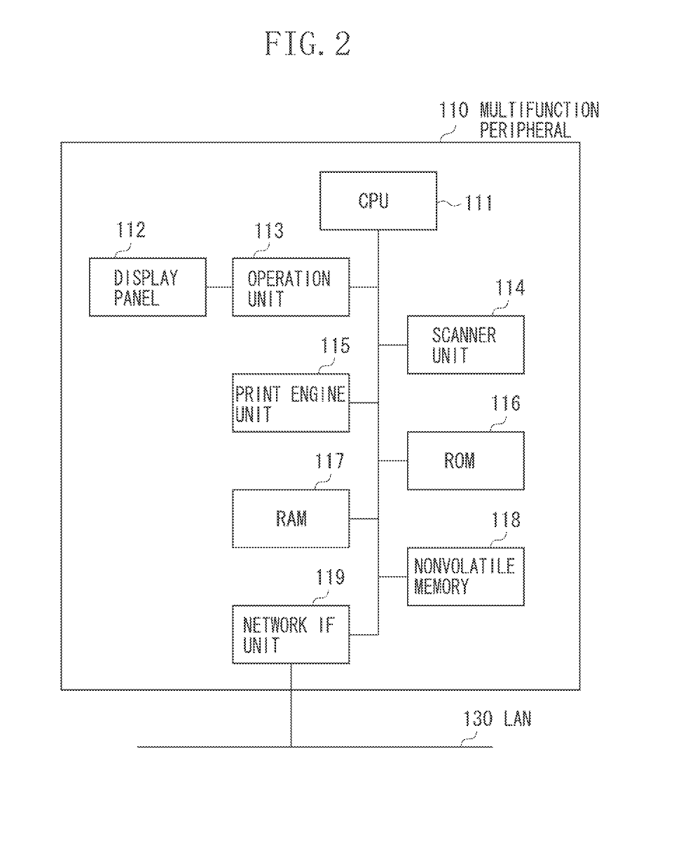

FIG. 2 illustrates an example of a hardware configuration of the multifunction peripheral 110. A central processing unit (CPU) 111 controls the multifunction peripheral 110. A display panel 112 displays various types of settings thereon. An operation unit 113 issues operation instructions to a scanner unit 114 and a print engine unit 115 and execution instructions of various programs. The scanner unit 114 reads a document and converts the read document into image data. The print engine unit 115 prints the image data.

A read only memory (ROM) 116 stores programs (program codes) for controlling the CPU 111, the scanner unit 114, and the print engine unit 115, and program codes for performing display by the display panel 112 and the operation unit 113. A random access memory (RAM) 117 is used as a work memory of the CPU 111 or the like. For example, the RAM 117 temporarily stores image data of a document read by the scanner unit 114, and temporarily stores the image data to be used for printing by the print engine unit 115. A nonvolatile memory 118 is an example of a storage unit and serves as a flash ROM or a hard disk (HDD) which stores job logs and the like.

A network interface (IF) unit 119 connects the multifunction peripheral 110 to the LAN 130. For example, the network IF unit 119 receives a print job from an external device (e.g., the print server 122) connected to the LAN 130, and transmits a job log to the external device (e.g., the log collection server 124). In the present exemplary embodiment, the functions in the multifunction peripheral 110 and processing illustrated in flowcharts described below are implemented by the CPU 111 performing processing in accordance with a procedure of a program stored in the ROM 116 or the like.

The hardware configuration of the information processing apparatuses, such as the PC 100 and the various servers 120 to 126 are similar to the hardware configurations of currently available computers. Thus, a detailed description and associated illustrations are omitted herein and a brief description provided. The information processing apparatus includes an input interface, a CPU, a ROM, a RAM, a nonvolatile memory, an output interface, and a network interface. Input devices, such as a keyboard and a mouse, are connected to the input interface. Output devices, such as a monitor and a display are connected to the output interface.

Various types of program codes are stored in the ROM. An application program group, an operating system (OS), a printer driver, and various types of data are stored in the nonvolatile memory. The RAM is used as a work memory by various programs stored in the nonvolatile memory. In the present exemplary embodiment, the functions described below in the information processing apparatus and the processing illustrated in the flowcharts described below are implemented by the CPU performing the processing in accordance with a procedure of the program stored in the ROM or the like.

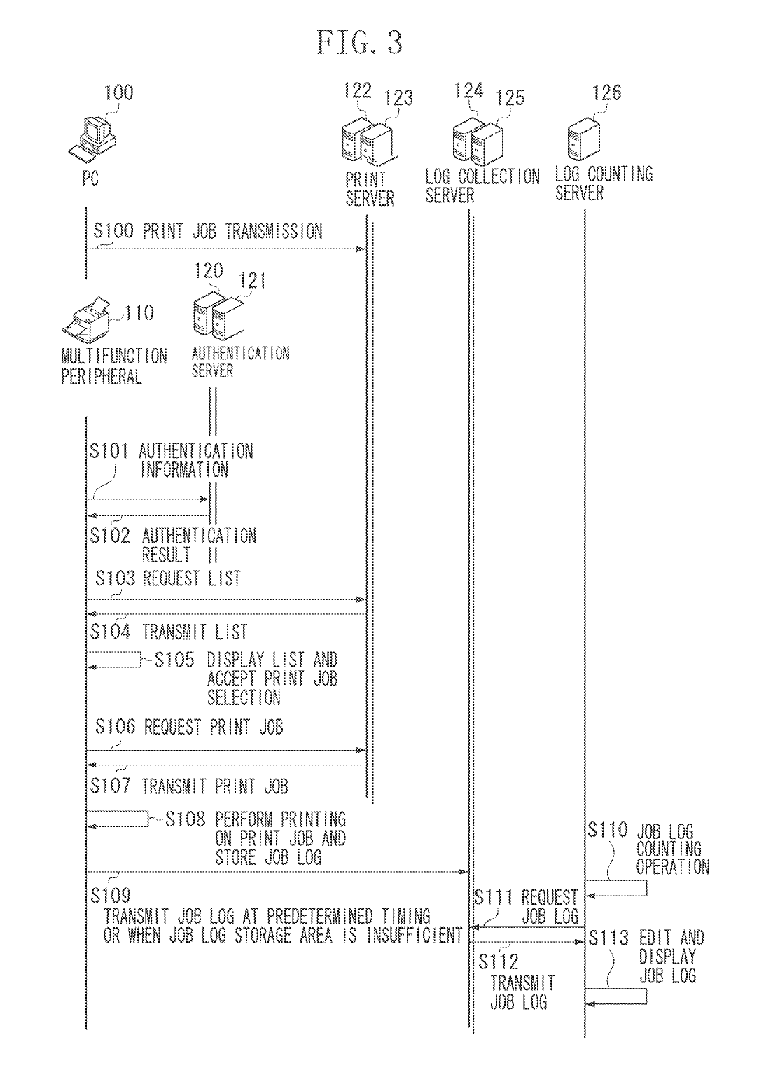

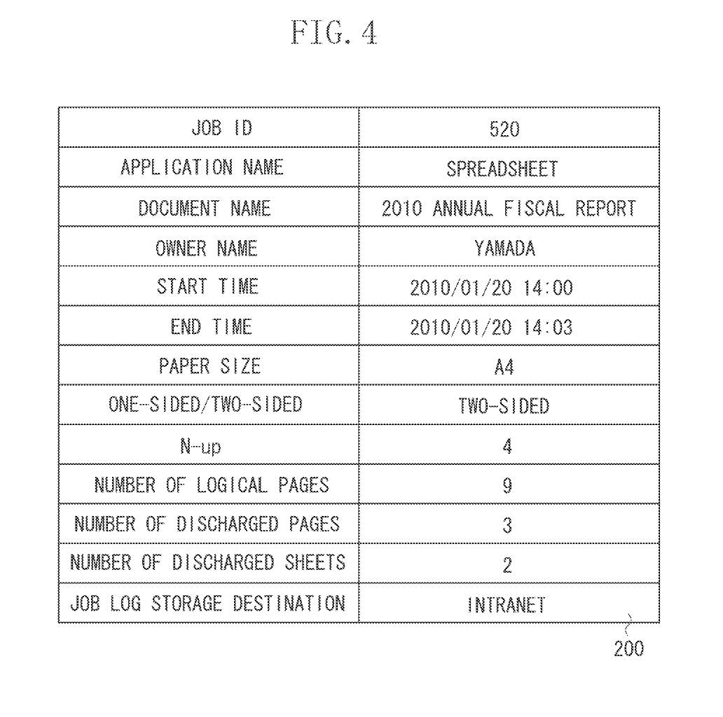

FIG. 3 illustrates an example of a sequence of operations of the PC 100, the multifunction peripheral 110, and the various servers 120 to 126. More specifically, FIG. 3 illustrates an example of a configuration for processing a print job and a job log of the print job. The job log includes information in the print job and information at the time of printing. Configuration details of the job log will be described below with reference to FIG. 4.

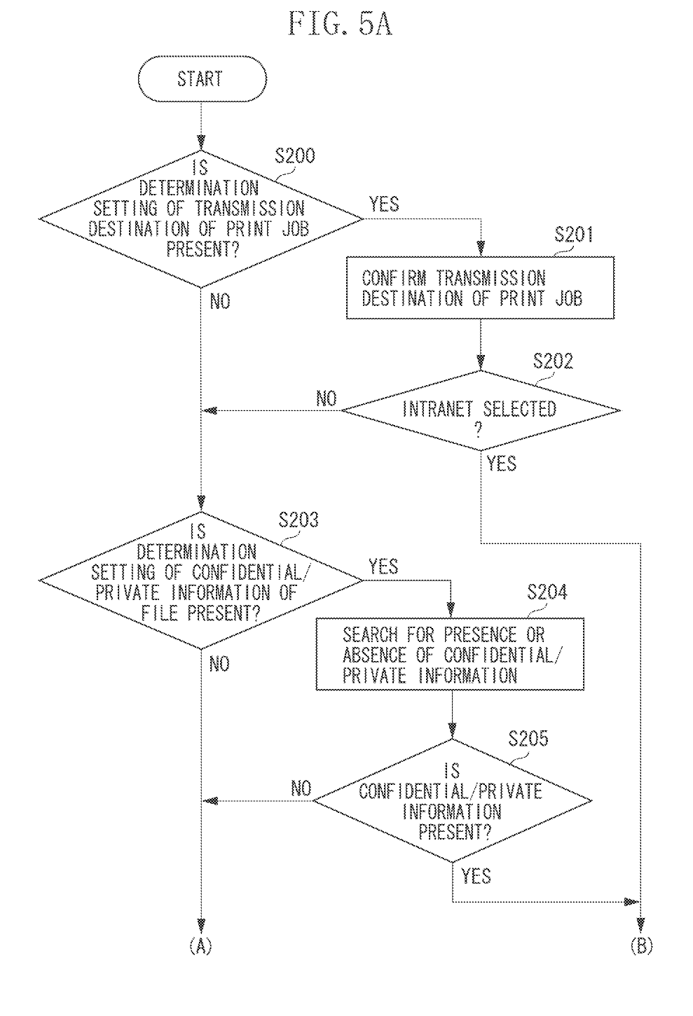

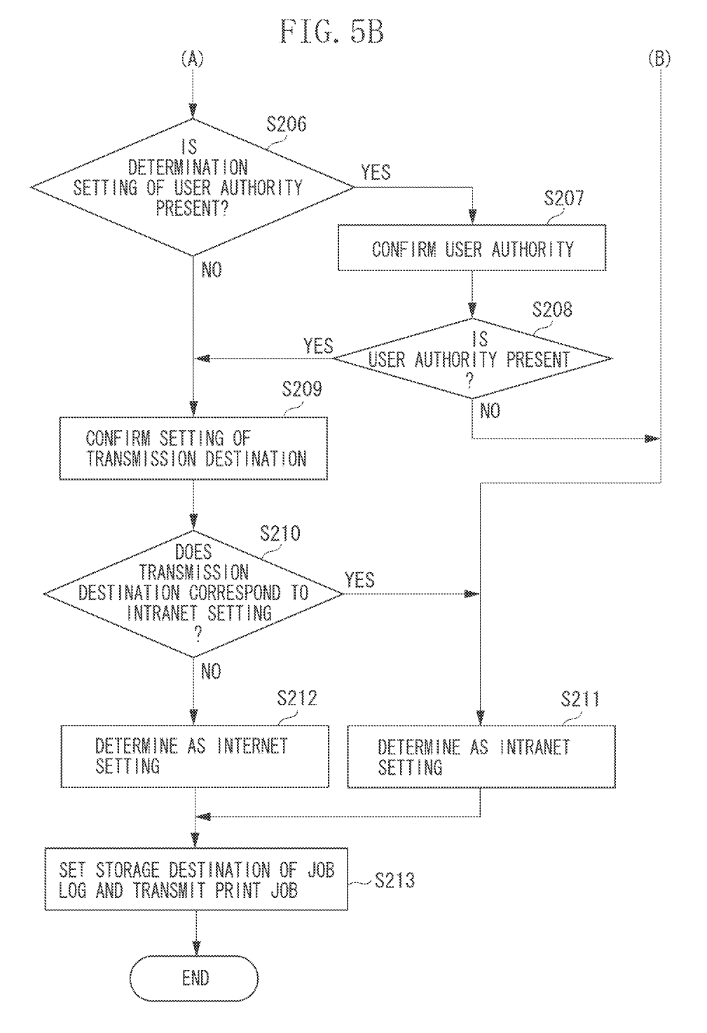

In step S100, the PC 100 transmits a print job to the print server 122 or 123. At this time, the PC 100 receives a user operation for selecting a print server of a transmission destination, adds identification information 200 described below to the print job, and transmits the print job to the selected print server. The details of the processing in which the PC 100 transmits the print job will be described below with reference to FIGS. 5A and 5B. Here, the print server 122 or 123 stores the received print job in a storage apparatus.

In step S101, the multifunction peripheral 110 receives an operation for performing user authentication via the operation unit 113 and transmits authentication information including information obtained according to the operation to the authentication server 120 or 121.

In step S102, the authentication server 120 or 121 transmits a result of the user authentication to the multifunction peripheral 110. Hereinbelow, a case in which the user authentication has been normally performed will be described by way of an example.

In the present example, a known authentication method can be used, and as such, a detailed description of the authentication method will be omitted. For example, an authentication method is used wherein user information (e.g., a user identification (ID) and a password) is input from the operation unit 113, or the user information is read from an integrated circuit (IC) card or the like, and the user authentication is performed using authentication information including the user information.

In step S103, the multifunction peripheral 110, in response to an operation in the operation unit 113, transmits a request for acquiring a print job list (list request) to the print server 122 or 123.

In step S104, the print server 122 or 123 transmits the print job list in response to the list request to the multifunction peripheral 110. The print job list includes, for example, information about the print job which the PC 100 has transmitted in step S100.

In step S105, the multifunction peripheral 110 displays the print job list acquired in step S104 on the display panel 112, and receives selection of a print job of a target to be printed via the operation unit 113.

In step S106, the multifunction peripheral 110 transmits a request for acquiring the print job of the print target (print job request) to the print server 122 or 123. In step S107, the print server 122 or 123 transmits the print job in response to the print job request to the multifunction peripheral 110.

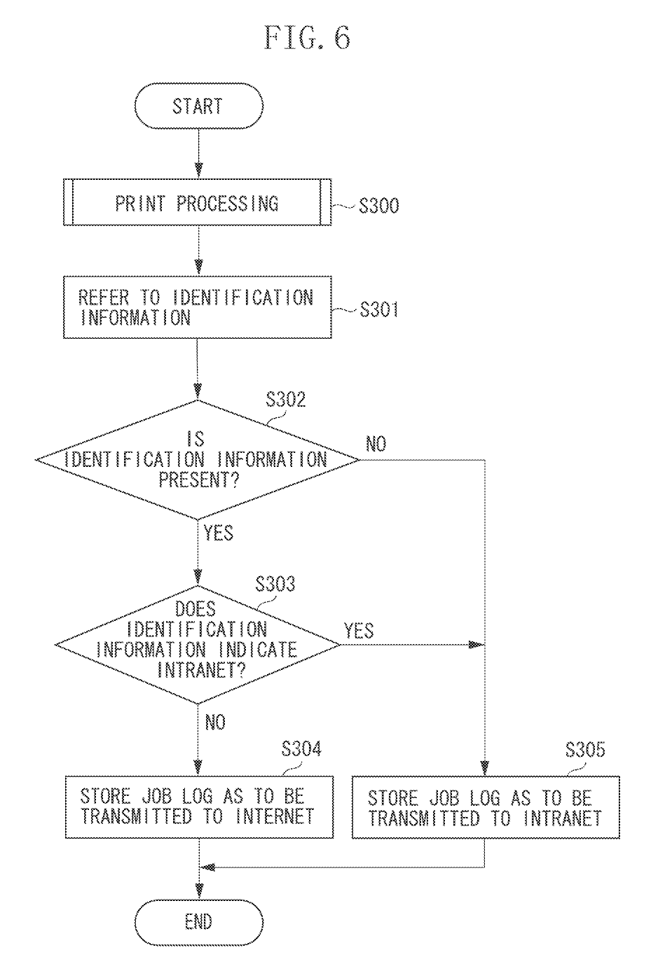

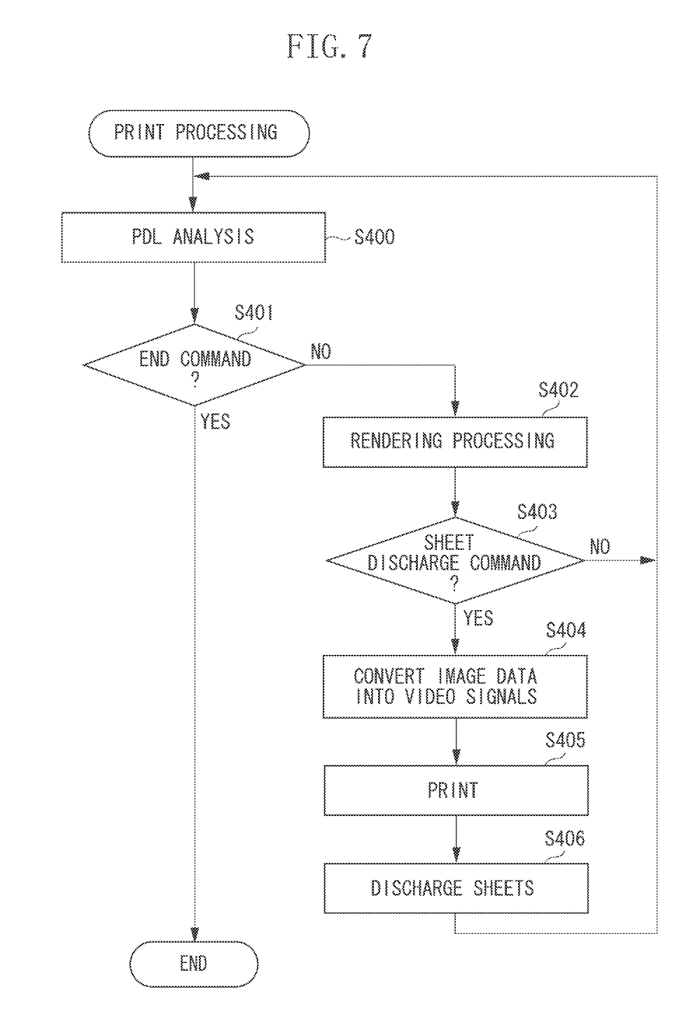

In step S108, the multifunction peripheral 110 performs print processing on the print job acquired in step S107, and stores a job log generated at this processing in the nonvolatile memory 118. The details of the processing will be described below with reference to FIGS. 6 and 7.

In step S109, the multifunction peripheral 110 determines a transmission destination and transmits the job log at a predetermined timing, e.g., at the end of each month, at the end of a week, etc., or when there is insufficient storage area in the nonvolatile memory 118 for storing the job log.

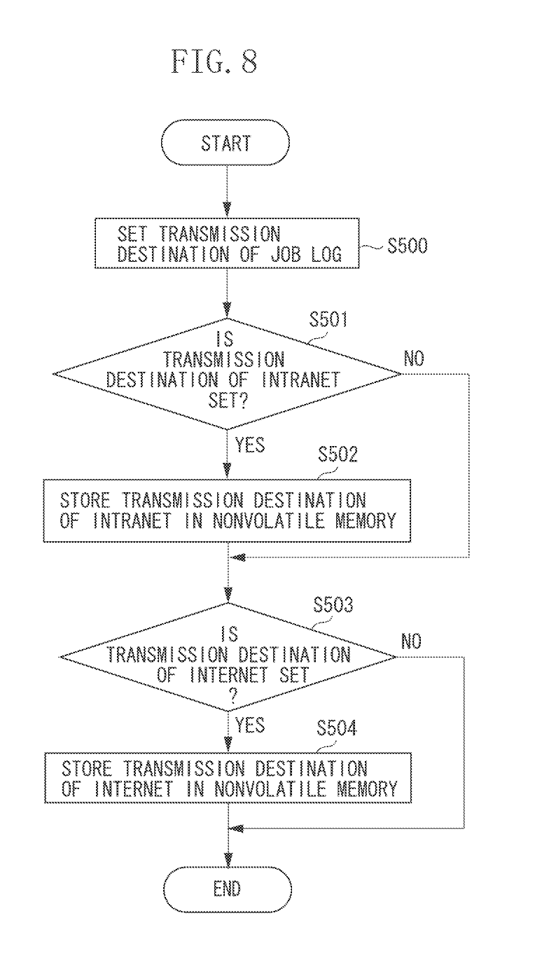

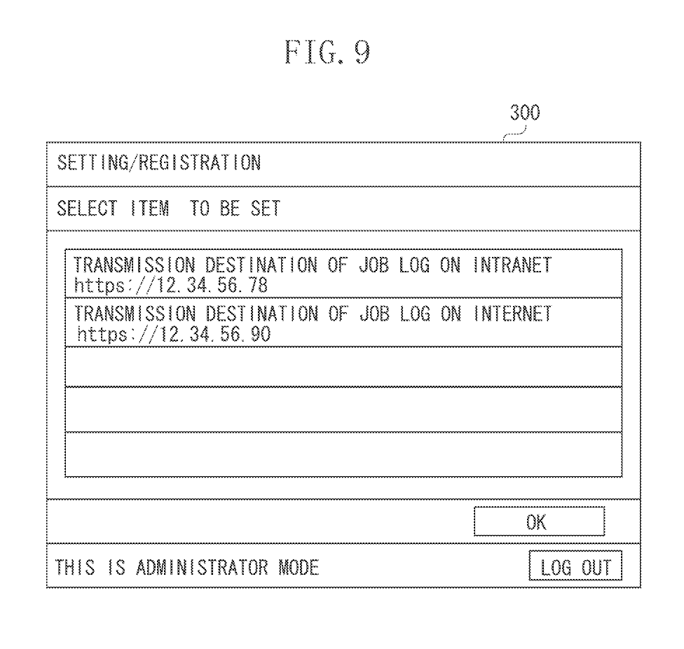

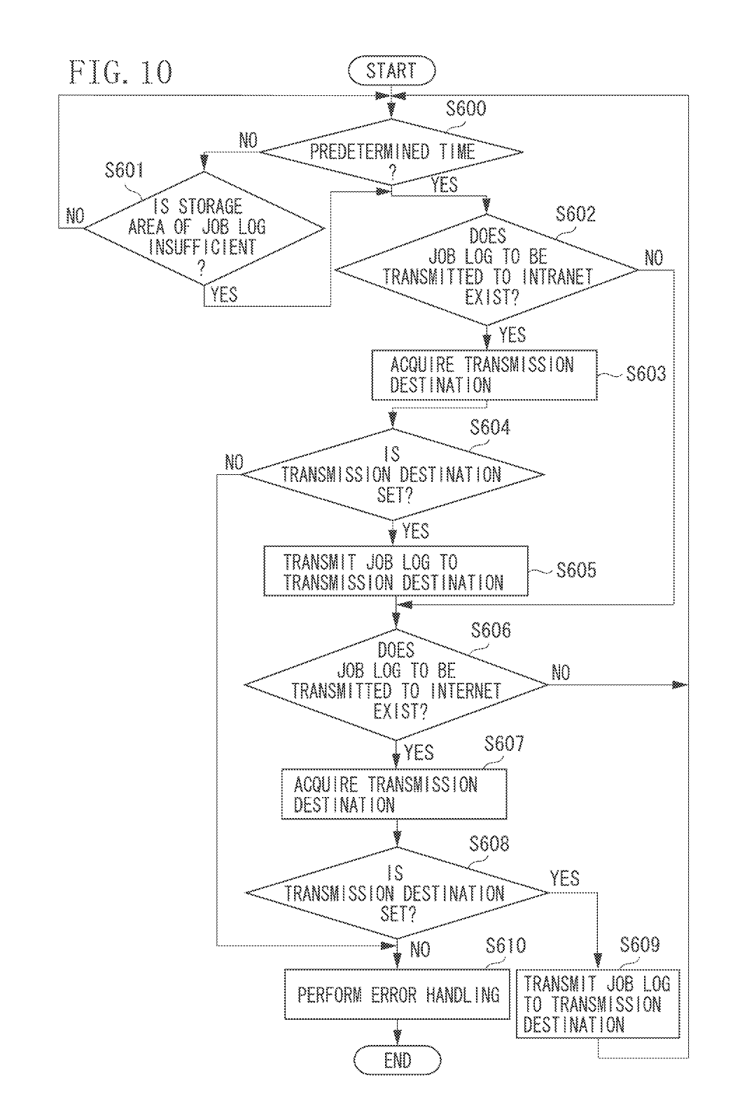

The details of processing for setting the transmission destination of the job log will be described below with reference to FIGS. 8 and 9. Further, the details of processing for transmitting the job log will be described below with reference to FIG. 10.

In step S110, the log counting server 126 receives a job log counting operation. In step S111, the log counting server 126 transmits a request for acquiring the job log according to the job log counting operation (job log request) to the log collection server 124 or 125. In another embodiment, multiple log collection servers can be selected and job logs collected from multiple log collection servers.

In step S112, the log collection server 124 or 125 transmits the job log in response to the job log request to the log counting server 126.

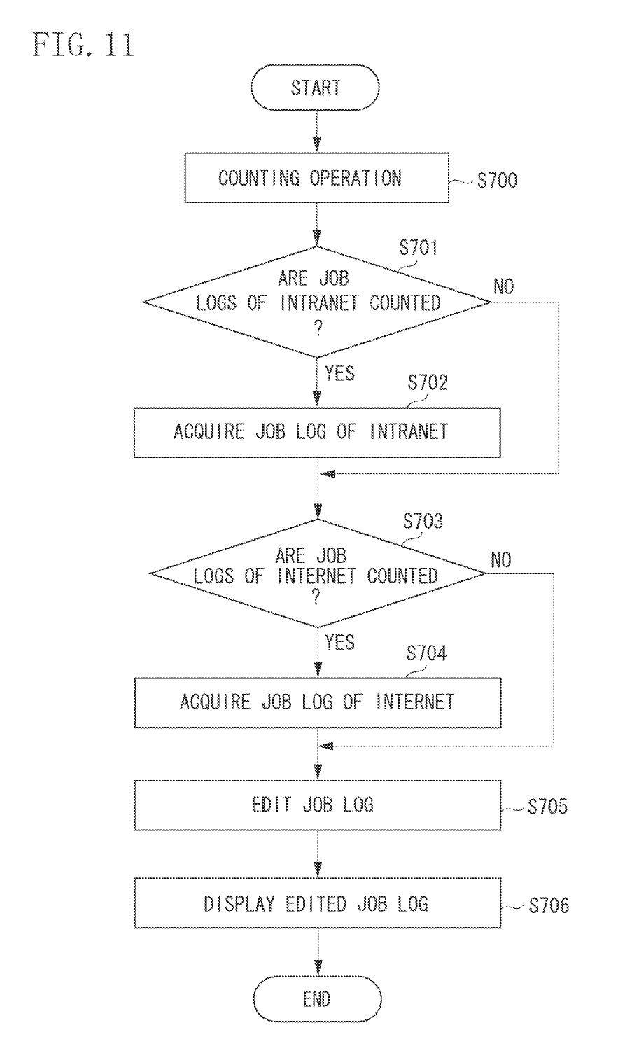

In step S113, the log counting server 126 edits the job log and displays the edited job on a display or the like. The details of the processing in steps S110 through step S113 are described below with reference to FIG. 11.

FIG. 4 illustrates an example of a configuration of a job log. The job log includes information about a job ID assigned thereto at the time of print start for identifying a print job, a name of an application that created the print job, a document name, an owner name that identifies a user who issued a print instruction, print start time, and a print end time. The job log further includes setting information associated with the printer driver, such as designation of a sheet size, designation of one-sided/two-sided printing, and an N-up designation for setting how many logical pages are laid out on printing paper, at the time of printing.

Furthermore, the job log includes information about a number of logical pages of the print job when created by the application, a number of discharged pages indicating a number of print surfaces when one-sided/two-sided printing or N-up printing is designated, and a number of discharged sheets. The job log includes information about a job log storage destination (e.g., the identification information 200) as an example of transmission destination information indicating a transmission destination of the job log. The identification information 200 is information to be added to a job by the PC 100, and is used as information for identifying the transmission destination of the job log.

FIGS. 5A and 5B are an example of a flowchart illustrating processing executed by the printer driver on the PC 100 to transmit a print job to the print server 122 or 123 (print job transmission processing). In the print job transmission processing, the identification information 200 for identifying the transmission destination of the job log generated by the multifunction peripheral 110 is added to the print job according to setting or operation of the printer driver.

In the present exemplary embodiment, the Intranet and the Internet are illustrated as two of the transmission destinations of the job log, however, the transmission destination may be selected and set from two or more transmission destinations. In the present exemplary embodiment, the use of the terms Internet and Intranet are consistent with the commonly known usage of these terms.

Turning to FIG. 5A, in step S200, the PC 100 determines whether a function for automatically determining the transmission destination of the job log has been set in conjunction with the transmission destination of the print job. If it is determined that the function is set (YES in step S200), the flow proceeds to step S201. If it is determined that the function is not set (NO in step S200), the flow proceeds to step S203.

In step S201, the PC 100 confirms the transmission destination of the print job, and determines the transmission destination (storage destination) of the job log based on the transmission destination of the print job. For example, if the print server 122 is selected as the transmission destination of the print job, the PC 100 determines information indicating the Intranet as the identification information 200, since the print server 122 is a server on the Intranet.

On the other hand, if the print server 123 is selected as the transmission destination of the print job, the PC 100 determines information indicating the Internet as the identification information 200, since the print server 123 is a server on the Internet.

In step S202, the PC 100 determines whether information of the Intranet is determined as the identification information 200. If it is determined that information of the Intranet is determined as the identification information 200 (YES in step S202), the flow proceeds to step S211. If it is determined that information of the Intranet has not been determined as the identification information 200 (NO in step S202), the flow proceeds to step S203.

In step S203, the PC 100 determines whether the function for determining that confidential or private information is included in a file of a print job has been set. If it is determined that the function is set (YES in step S203), the flow proceeds to step S204. If it is determined that the function is not set (NO in step S203), the flow proceeds to step S206.

In step S204, the PC 100 searches whether confidential information or private information is included in the file. In the present exemplary embodiment, information determined as the confidential information or private information is set in advance, and is character strings such as “FOR INTERNAL USE ONLY”, “COPY INHIBITED”, or “CONFIDENTIAL”. The method for searching whether this information is present in a file is well known in the art, and as such, a detailed description of the method is omitted herein.

In step S205, the PC 100 determines whether the confidential information or private information is included in the file. If it is determined that the confidential information or the private information is included (YES in step S205), the flow proceeds to step S211. If it is determined that it is not included (NO in step S205), the flow proceeds to step S206.

In step S206, the PC 100 determines whether a function for automatically determining the authority of a user has been set. If it is determined that the function is set (YES in step S206), the flow proceeds to step S207. If it is determined that the function is not set (NO in step S206), the flow proceeds to step S209.

In step S207, the PC 100 confirms the user authority. Confirmation of user authority is done via any commonly known methods, and as such, a detailed description is omitted herein.

Next, in step S208, the PC 100 determines whether the user authority is present. If the user authority is present, the PC 100 may determine levels of the user authority (not shown). If it is determined that the user authority is absent, or that the user authority is below a predetermined level of authority (NO in step S208), the flow proceeds to step S211. If it is determined that the user authority is present or that the user authority is above a predetermined level of authority) (YES in step S208), the flow proceeds to step S209.

In step S209, the PC 100 confirms the transmission destination. This is done by referring to the settings of the printer driver. The settings indicate, for example, whether the Intranet or the Internet is the transmission destination of the job log, and can be set by the user via an input device or the like.

In step S210, the PC 100 determines whether the transmission destination is the Intranet. If it is determined that the transmission destination is the Intranet (YES in step S210), the flow proceeds to step S211. If it is determined that the transmission destination is not the Intranet (NO in step S210), the flow proceeds to step S212.

In step S211, the PC 100 sets information indicating the Intranet to the identification information 200, and in the flow proceeds to step S213. In step S212, the PC 100 sets information indicating the Internet for the identification information 200, and the flow proceeds to step S213. In other words, the PC 100 determines the transmission destination of the job log.

In step S213, the PC 100 adds the identification information 200 to the generated print job, transmits it to the print server 122 or 123, and ends the print job transmission processing. The generation of the print job (page description language (PDL) data) is a method commonly known in the art, and thus a detailed description is omitted herein.

FIG. 6 is a flowchart illustrating an example of a series of processing (processing in printing) in which the multifunction peripheral 110 performs print processing, and generates and stores the job log.

In step S300, the multifunction peripheral 110 performs print processing on the print job acquired from the print server 122 or 123. The details of print processing will be described below with reference to FIG. 7. Next, in step S301, the multifunction peripheral 110 refers to the identification information 200 stored in the print job.

Then, in step S302, the multifunction peripheral 110 determines whether the identification information 200 exists within the print job. If it is determined that the identification information 200 exists (YES in step S302), the flow proceeds to step S303. If it is determined that the identification information 200 does not exist (NO in step S302), the flow proceeds to step S305.

In step S303, the multifunction peripheral 110 determines whether information indicating the Intranet is set in the identification information 200. If it is determined that information indicating the Intranet is set (YES in step S303), the flow proceeds to step S305. If it is determined that information indicating the Intranet is not set (NO in step S303), the flow proceeds to step S304.

For the identification information included in a job, information such as transmission source of the job may be used. For example, if print processing is performed via the print server 123 on the Internet, the information may be stored on the Internet. Thus, the transmission destination of the job log can be identified as the log collection server 125 on the Internet.

In step S304, the multifunction peripheral 110 stores the job log as to be transmitted to the Internet in the nonvolatile memory 118, and ends the processing in printing.

In step S305, the multifunction peripheral 110 stores the job log as to be transmitted to the Intranet in the nonvolatile memory 118, and ends the processing in printing. In the nonvolatile memory 118, the job log to be transmitted to the Intranet, and the job log to be transmitted to the Internet are stored separately from each other.

FIG. 7 illustrates an example of a flowchart for print processing of a print job.

In step S400, the multifunction peripheral 110 analyzes the PDL data in the print job received via the network IF unit 119.

Then, in step S401, the multifunction peripheral 110 determines whether a command obtained by the analysis is an end command. If it is determined that the command is the end command (YES in step S401), the multifunction peripheral 110 ends the print processing. If it is determined that the command is not the end command (NO in step S401), the flow proceeds to step S402.

In step S402, the multifunction peripheral 110 performs generation processing (rendering processing) of image data.

Next, in step S403, the multifunction peripheral 110 determines whether a command obtained by the analysis is a sheet discharge command. If it is determined that the command is the sheet discharge command (YES in step S403), the flow proceeds to step S404. If it is determined that the command is not the sheet discharge command (NO in step S403), in the flow proceeds to step S400. More specifically, the multifunction peripheral 110 performs generation processing (rendering processing) of the image data in accordance with each command described in the PDL data, until it is determined that the sheet discharge command of printing paper exists in the PDL data.

In step S404, the multifunction peripheral 110 converts the generated image data into a video signal, and transfers the video signal to the print engine unit 115. Then, in step S405, the multifunction peripheral 110 performs printing via the print engine unit 115. In step S406, the multifunction peripheral 110 discharges the sheet(s) on which printing has been completed, and the flow returns to step S400. The print processing is not limited to the above-described configuration, and any known print processing is applicable.

FIG. 8 illustrates an example of a flowchart for processing in which the multifunction peripheral 110 receives setting of the transmission destination of the job log (transmission destination setting processing).

In step S500, the multifunction peripheral 110 displays, for example, a setting screen 300 illustrated in FIG. 9 on the display panel 112, and receives setting of the transmission destination of the job log via the operation unit 113.

In step S501, the multifunction peripheral 110 determines whether a transmission destination of the Intranet is set. If it is determined that the transmission destination of the Intranet is set (YES in step S501), the flow proceeds to step S502. If it is determined that the transmission destination of the Intranet is not set (NO in step S501), the flow proceeds to step S503.

In step S502, the multifunction peripheral 110 stores the transmission destination of the Intranet (a setting value such as an IP address) in the nonvolatile memory 118.

In step S503, the multifunction peripheral 110 determines whether a transmission destination of the Internet is set. If it is determined that the transmission destination of the Internet is set (YES in step S503), the flow proceeds to step S504. If it is determined that the transmission destination of the Internet is not set (NO in step S503), the multifunction peripheral 110 ends the transmission destination setting processing.

In step S504, the multifunction peripheral 110 stores the transmission destination of the Internet in the nonvolatile memory 118, and then ends the transmission destination setting processing. The setting by the transmission destination setting processing is based on the premise that the setting is performed before a start of the processing in printing in FIG. 6, and the setting value of the transmission destination is utilized in the processing in FIG. 10.

FIG. 9 illustrates an example of a screen (setting screen 300) for setting a transmission destination of a job log in the multifunction peripheral 110. The setting screen 300 is displayed on the display panel 112, and receives an operation for setting the transmission destination of the job log via the operation unit 113. On the setting screen 300, an IP address (setting value) of the transmission destination is input, and the setting value is stored in the nonvolatile memory 118.

FIG. 10 illustrates an example of a flowchart for processing in which the multifunction peripheral 110 transmits the job log (job log transmission processing). As illustrated in the flowchart, the multifunction peripheral regularly transmits the job log to a log collection server based on a predetermined regular transmission time.

In step S600, the multifunction peripheral 110 determines whether a predetermined time is reached. If it is determined that the predetermined time has been reached (YES in step S600), flow proceeds to step S602. If it is determined that the predetermined times has not been reached (NO in step S600), flow proceeds to step S601.

In step S601, the multifunction peripheral 110 determines whether a storage area of the nonvolatile memory 118 for storing the job log is insufficient. If it is determined as insufficient (YES in step S601), the flow proceeds to step S602. If it is determined to be sufficient (NO in step S601), the flow returns to step S600. In other words, if it is determined that the predetermined time has not been reached, the multifunction peripheral 110 performs transmission of the job log in step S602 and the subsequent steps, in a case where the storage area of the multifunction peripheral 110 is determined as insufficient.

Processing in step S602 to step S605 is an example of the processing when the multifunction peripheral 110 transmits the job log to the log collection server 124 on the Intranet.

In step S602, the multifunction peripheral 110 determines whether the job log to be transmitted to the log collection server 124 on the Intranet exists in the nonvolatile memory 118. If it is determined that the job log exists in the nonvolatile memory 118 (YES in step S602), the flow proceeds to step S603. If it is determined that the job log does not exist (NO in step S602), the flow proceeds to step S606.

In step S603, the multifunction peripheral 110 acquires the transmission destination (setting value) of the job log from the nonvolatile memory 118.

Next, in step S604, the multifunction peripheral 110 determines whether the transmission destination is set. If it is determined that the transmission destination is set (YES in step S604), then in step S605, the multifunction peripheral 110 transmits the job log according to the setting value of the acquired transmission destination. Flow then proceeds to step S606. If it is determined that the transmission destination is not set (NO in step S604), the flow proceeds to S610.

Processing in steps S606 to step S609 is an example of the processing when the multifunction peripheral 110 transmits the job log to the log collection server 125 on the Internet.

In step S606, the multifunction peripheral 110 determines whether the job log to be transmitted to the log collection server 125 on the Internet exists in the nonvolatile memory 118. If it is determined that the job log exists in the nonvolatile memory 118 (YES in step S606), the flow proceeds to step S607. If it is determined that the job log does not exist (NO in step S606), the flow returns to step S600.

In step S607, the multifunction peripheral 110 acquires the transmission destination (setting value) of the job log from the nonvolatile memory 118. Then, in step S608, the multifunction peripheral 110 determines whether the transmission destination is set. If it is determined that the transmission destination is set (YES in step S608), then in step S609, the multifunction peripheral 110 transmits the job log according to the acquired setting value of the transmission destination. The flow then returns to step S600. If it is determined that the transmission destination is not set (NO in step S608), the flow proceeds to step S610.

In step S610, the multifunction peripheral 110 performs error handling, such as performing error display on the display panel 112.

As described above, the present exemplary embodiment can prevent the job log including confidential information or private information from being referenced from the Internet by transmitting the job log to the log collection server 124 on the Intranet. On the other hand, by transmitting the job log to the log collection server 125 on the Internet, job logs can be collected from a plurality of stations, which allows sharing of the server.

FIG. 11 illustrates an example of a flowchart for processing in which the log counting server 126 counts job logs (counting processing).

In step S700, the log counting server 126 receives a counting operation of the job logs. The counting operation includes an operation for instructing collection and display of the job logs stored in the log collection server 124, and an operation of instructing collection and display of the job logs stored in the log collection server 125. Further, the log counting server 126 also receives an operation for collecting the job logs from both servers and instructing display of the combined job logs.

In step S701, the log counting server 126 determines whether an operation for counting the job logs stored in the log collection server 124 (the job logs of the Intranet) has been performed. If it is determined that the counting operation has been performed (YES in step S701), then in step S702, the log counting server 126 acquires the job log from the log collection server 124, and the flow proceeds to step S703. If it is determined that the counting operation has not been performed (NO in step S701), the flow proceeds to step S703.

In step S703, the log counting server 126 determines whether an operation for counting the job logs stored in the log collection server 125 (the job logs of the Internet) has been performed. If it is determined that the counting operation has been performed (YES in step S703), then in step S704, the log counting server 126 acquires the job log from the log collection server 125, and flow proceeds to step S705. If it is determined that the counting operation has not been performed (NO in step S703), the flow proceeds to step S705.

In step S705, the log counting server 126 performs editing, such as combining the job logs acquired in step S702 or in step S704. Next, in step S706, the log counting server 126 displays the edited job log on a display connected to the log counting server, and then the processing ends.

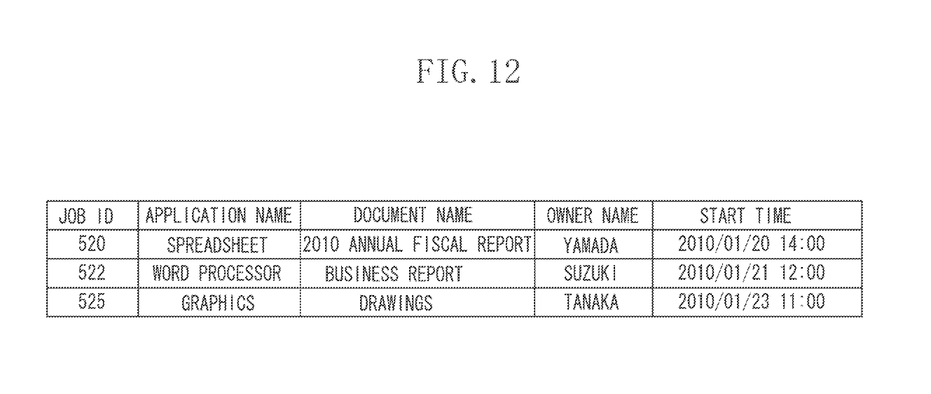

FIG. 12 illustrates an example of a screen on which the job log acquired from the log collection server 124 is displayed on the display of the log counting server 126. In this example, a job ID, an application name, a document name, an owner name, and a start time are indicated. The items that can be displayed are not limited to the above.

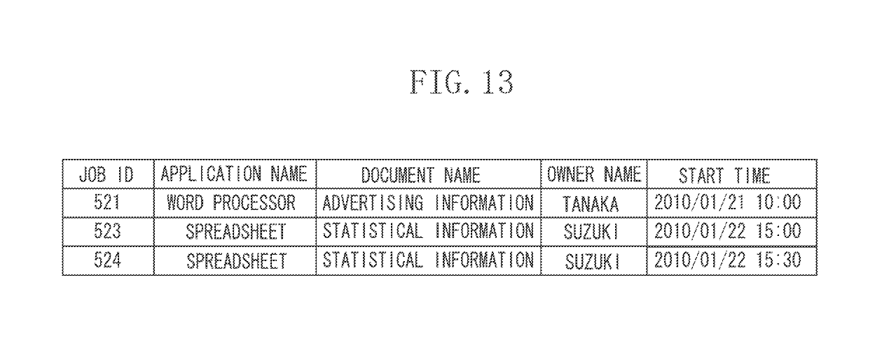

FIG. 13 illustrates an example of a screen on which the job log acquired from the log collection server 125 is displayed on the display of the log counting server 126.

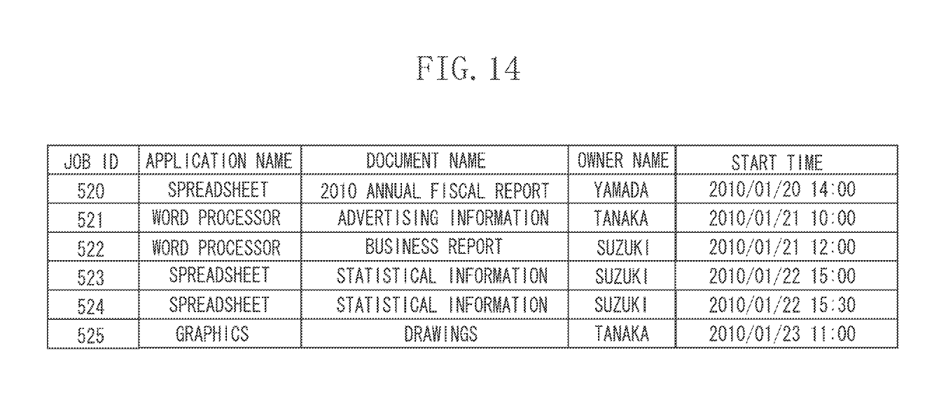

FIG. 14 illustrates an example of a screen on which the job logs acquired from the log collection server 124 and the job logs acquired from the log collection server 125 are combined by the log counting server 126, rearranged in the order of job IDs, and displayed.

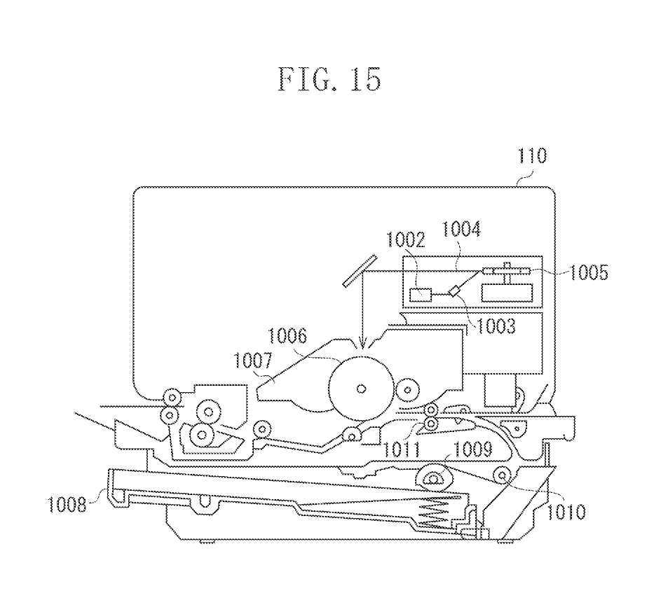

FIG. 15 illustrates an example of a configuration in which a laser beam printing method is adopted as the print engine unit 115 of the multifunction peripheral 110.

First, image data is converted into a video signal and transferred to a laser driver 1002. The laser driver 1002 is a circuit for driving a semiconductor laser 1003, and performs switching on/off of a laser beam 1004 emitted from the semiconductor laser 1003 according to the input video signals.

The laser beam 1004 is shifted in right and left directions by a rotational polygon mirror 1005 to scan and expose a surface of an electrostatic drum 1006. Thus, an electrostatic latent image of an output image is formed on the surface of the electrostatic drum 1006. The latent image is developed by a developing unit 1007 disposed around the electrostatic drum 1006, and then transferred onto printing paper.

The printing paper is stored in a printing paper cassette 1008 mounted on a main body of the print engine unit 115, taken into the apparatus by a sheet feeding roller 1009, and conveyance rollers 1010 and 1011, and then supplied to the electrostatic drum 1006. While the present exemplary embodiment is described with respect to a laser beam printer, it is not limited to a laser beam printer, and any another type of printer, such as an inkjet printer, a sublimation printer, a silver halide printer, etc. may be used.

As described above, according to the present exemplary embodiment, when a print job is generated by the printer driver, identification information for designating a transmission destination of the job log is added to the print job. Further, when a job log is generated, the multifunction peripheral individually creates and manages the job log to be transmitted to the Intranet and the job log to be transmitted to the Internet by referring to the identification information (added information).

As described above, confidential information and private information can be prevented from being transmitted to the Internet by selectively using the server on the Intranet and the server on the Internet as a storage destination of the job log.

In a second exemplary embodiment, instead of a configuration for managing a job log by dividing it (e.g., by a plurality of files) as described in the first exemplary embodiment, a configuration for storing a job log as one job log (e.g., by one file) in the nonvolatile memory 118 regardless of its transmission destination can be used. According to the present exemplary embodiment, a job log to be transmitted to the server on the Intranet and a job log to be transmitted to the server on the Internet is separately extracted and transmitted by referring to the identification information 200 in the job log.

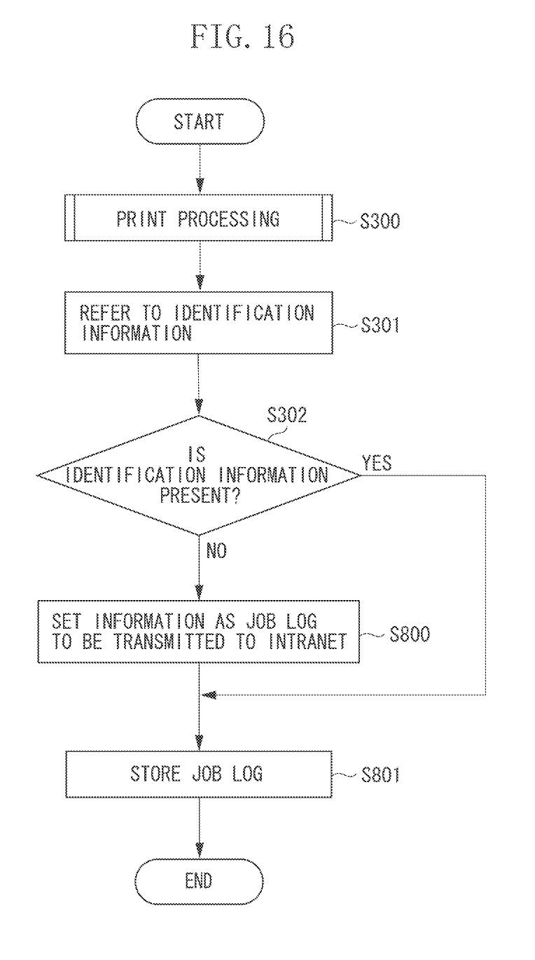

FIG. 16 illustrates an example of a flowchart for the processing at the time of printing according to the present embodiment. The processing from steps S300 to S302 in FIG. 16 are similar to the steps illustrated in FIG. 6, and as such, their descriptions are not repeated herein.

If it is determined in step S302 that the identification information 200 does not exist in a print job (NO in step S302), then in step S800, the multifunction peripheral 110 sets information indicating the Intranet to the identification information 200 of the print job. This enables handling the job log as to be transmitted to the server on the Intranet. The flow then proceeds to step S801.

In step S801, the multifunction peripheral 110 stores a single job log in the nonvolatile memory 118 regardless of the transmission destination of the job log, and then the processing ends. More specifically, if it is determined that the information indicating the Intranet is set to the identification information 200 of the print job, the multifunction peripheral 110 stores the job log as to be transmitted to the log collection server 124 on the Intranet in the nonvolatile memory 118. On the other hand, if it is determined the information indicating the Intranet is not set, the multifunction peripheral 110 stores the job log as to be transmitted to the log collection server 125 on the Internet in the nonvolatile memory 118.

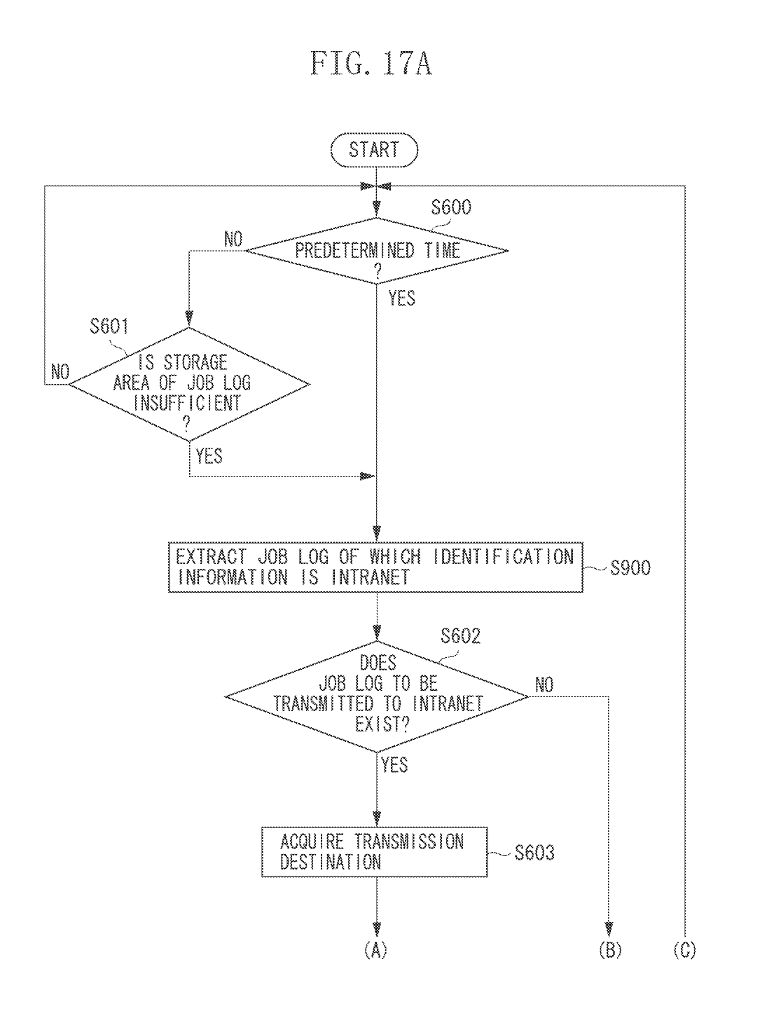

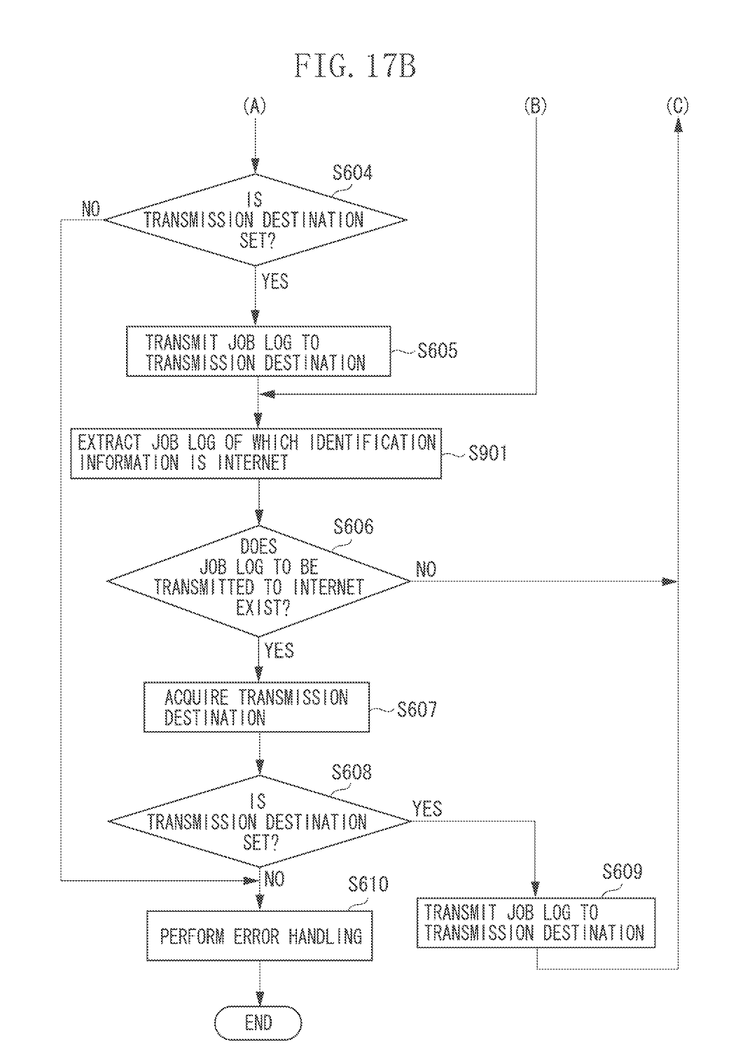

FIGS. 17A and 17B illustrate an example of a flowchart for the job log transmission processing. The processing from steps S600 to S610 in FIGS. 17A and 17B are similar to the corresponding steps in FIG. 10, and thus their descriptions are not repeated herein.

In step S900, the multifunction peripheral 110 extracts the job log including the identification information 200 indicating the Intranet from the job logs stored in the nonvolatile memory 118. The multifunction peripheral 110 transmits the extracted job log to the log collection server 124 on the Intranet in step S602 through step S605.

In step S901, the multifunction peripheral 110 extracts the job log including the identification information 200 indicating the Internet from the job logs stored in the nonvolatile memory 118. The multifunction peripheral 110 transmits the extracted job log to the log collection server 125 on the Internet in step S606 through step S609.

As described above, according to the present exemplary embodiment, the multifunction peripheral 110 does not manage the job logs by separating the job log to be transmitted to the Intranet and the job log to the Internet, and stores the job logs as one job log in the nonvolatile memory 118 regardless of the transmission destination thereof. According to the configuration, when a job log is transmitted to the log collection server, the job log to be transmitted to the server on the Intranet and the job log to be transmitted to the server on the Internet can be separately extracted and transmitted by referring to the identification information 200 in the job log.

The present invention can be also realized by executing the following processing. More specifically, software (a program) for realizing the functions of the above exemplary embodiments is supplied to a system or an apparatus via a network or various computer-readable storage media and a computer (or CPU or micro processing unit (MPU)) of the system or the apparatus reads and executes the program. In this case, the program and the computer-readable storage media storing the program constitutes the present invention.

According to the configuration of the above-described exemplary embodiments, a job log can be more appropriately managed.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-210874 filed Sep. 21, 2010, which is hereby incorporated by reference herein in its entirety.

What is claimed is:

1. An image forming apparatus capable of transmitting a job log relating to a processed job to a first storage apparatus existing on an Internet outside a firewall and a second storage apparatus existing inside a firewall, the image forming apparatus comprising:
an identification unit configured to identify a job log to be generated when a job is processed as a job log to be transmitted to the first storage apparatus or a job log to be transmitted to the second the storage apparatus according to information for identifying a transmission destination included in the job; and
a transmission unit configured to transmit the generated job log to the transmission destination identified by the identification unit.

2. The image forming apparatus according to claim 1, wherein if information for identifying a transmission destination is not included in a job, the identification unit identifies that the generated job log is transmitted to the second storage apparatus.

3. The image forming apparatus according to claim 1, wherein information for identifying a transmission destination included in a job is information designated by a user in an information processing apparatus that generates the job.

4. The image forming apparatus according to claim 1, wherein if it is identified by information included in the job that the job is transmitted to the image forming apparatus via the Internet and processed, the identification unit identifies that the generated job log is transmitted to the first storage apparatus.

5. A system comprising a first storage apparatus existing on an Internet outside a firewall, a second storage apparatus existing inside a firewall, an image forming apparatus capable of generating a job log relating to a processed job, and a counting server,
wherein the image forming apparatus includes:
an identification unit configured to identify a job log to be generated when a job is processed as a job log to be transmitted to the first storage apparatus or a job log to be transmitted to the second the storage apparatus according to information for identifying a transmission destination included in the job; and
a transmission unit configured to transmit the generated job log to the transmission destination identified by the identification unit, and
wherein the counting server includes:
an output unit configured to acquire a job log from each of the first storage apparatus and the second storage apparatus and display the job log.

6. A method for managing a job log in an image forming apparatus capable of transmitting a job log relating to a processed job to a first storage apparatus existing on an Internet outside a firewall and a second storage apparatus existing inside a firewall, the method comprising:
identifying a job log to be generated when a job is processed as a job log to be transmitted to the first storage apparatus or a job log to be transmitted to the second the storage apparatus according to information for identifying a transmission destination included in the job; and
transmitting the generated job log to the identified transmission destination.

7. The method according to claim 6, further comprising, if information for identifying a transmission destination is not included in a job, identifying that the generated job log is transmitted to the second storage apparatus.

8. The method according to claim 6, wherein information for identifying a transmission destination included in a job is information designated by a user in an information processing apparatus that generates the job.

9. The method according to claim 6, further comprising, if it is identified by information included in the job that the job is transmitted to the image forming apparatus via the Internet and processed, identifying that the generated job log is transmitted to the first storage apparatus.

10. A computer readable storage medium on which is stored a computer program for making a computer execute a method for transmitting a job log to a first storage apparatus existing on an Internet outside a firewall and a second storage apparatus existing inside a firewall, the method comprising:
identifying a job log to be generated when a job is processed as a job log to be transmitted to the first storage apparatus or a job log to be transmitted to the second the storage apparatus according to information for identifying a transmission destination included in the job; and
transmitting the generated job log to the transmission destination.
